(19) United States
(12) Patent Application Publication
(10) Pub. No.: US 2014/0245366 A1
(43) Pub. Date: Aug. 28, 2014

(54) Method and Apparatus For Establishing a Time Base

(71) Applicant: Jeremy Bennett, Hampshire (GB)

(72) Inventor: Jeremy Bennett, Hampshire (GB)

(73) Assignee: Telefonaktiebolaget L M Ericsson (publ), Stockholm (SE)

(21) Appl. No.: 14/130,701

(22) PCT Filed: Jul. 4, 2011
(86) PCT No.: PCT/EP2011/061192

§ 371 Date: May 5, 2014

(51) Int. Cl. H04N 21/242; H04N 21/643

(52) U.S. Cl. CPC H04N 21/242; H04N 21/64322
USPC 725/109

(57) ABSTRACT

The present invention relates to a method of and apparatus for establishing a time base for variable data rate traffic data received from an asynchronous network. In some embodiments, the invention relates to a method of and apparatus for establishing a time base for a compression coded video signal transmitted over an Internet Protocol (IP) network. A method of establishing a traffic data time base for variable data rate traffic data received over an asynchronous network is provided in which a time base for the traffic data is established using a first method of time base recovery and a reliability metric for first method is determined. If the reliability metric shows that the first method is unreliable, a second method of establishing a time-base for the traffic data is used. In some embodiments the arrival timing of asynchronous network data is used in the step of establishing a time base for the traffic data using a first method of time-base recovery. In some embodiments the arrival timing of asynchronous network data is used in the step of determining the reliability metric. In some embodiments an internal traffic data time base is used in the step of establishing a time-base for the traffic data using a second method of time-base recovery. In some embodiments the traffic data is a compression coded signal. In some embodiments the asynchronous network is an Internet Protocol (IP) network.

### FIELD OF THE INVENTION

The present invention relates to a method of and apparatus for establishing a time base for variable data rate traffic data received from an asynchronous network. In some embodiments, the invention relates to a method of and apparatus for establishing a time base for a compression coded video signal transmitted over an Internet Protocol (IP) network.

### BACKGROUND

A time base is a clock signal that is used for timing or for synchronisation purposes at a network node or for a signal. In many systems, traffic data is encoded using the clock at a sending node as a time base, and is transferred over a network to a receiving node. In order to correctly decode the received traffic data, it is necessary that the clock at the receiving node, which is used as a time base for decoding the received traffic data, is synchronized with the time base clock of the sending node, which was used to encode the data.

One example of a situation in which it is necessary to establish a time base is in a digital television broadcast system where it is critical that a video stream decoder operates with its time-base locked to that of the video stream encoder to ensure that the two devices remain synchronized for an extended time. If the devices are not synchronized, then the decoder timing system will drift apart from that of the source encoder resulting in conflicts in the processing of the video and audio data streams and the eventual breakdown of the service.

The time base employed in coding systems defined by international standards such as MPEG, ATSC and DVB is related to a master encoder frequency of 27 MHz. In order to maintain stable synchronism, it is necessary to ensure that the decoder 27 MHz master clock source is aligned with the encoder 27 MHz master clock source. Jitter is defined as the deviation of the instantaneous time value at any point in a given signal compared with the correct value for a correct time base. Although some jitter in the 27 MHz master clock frequency is tolerable, the long term stability of the synchronism between the encoder time base and the decoder time base must be exact and so the jitter of the 27 MHz clock frequency is required to be less than +30 parts per million [ppm].

If this same tolerance was applied to the long term synchronism then, at a 25 Hz television frame rate, after only 1 million frames of video, corresponding to about 11 hours of broadcasting, 30 frames of misalignment will accrue or about 1 frame every 20 minutes. Without any means of controlling this rate of drift between the clocks the decoder will, at best, resynchronize frequently, causing an undesirable visible interruption of service, or, at worst, fail completely.

The requirement to synchronize the decoder time base with the encoder time base in television broadcasting systems is known and techniques are available to achieve the necessary synchronization. For example, it is a requirement of a professional television broadcasting system that all devices in the data flow path between encoder and decoder maintain an accurate time base at all times. Therefore it is best practice for a professional system to lock the time base of each of the devices downstream of the content originator to the time base of that originator and then the exact number of frames is decoded that was encoded.

In some systems, at least one additional complete television frame is stored in the decoder, and control circuits monitor the state of synchronism and make corrections to the reading of this store, for example by repeating some video frames when the frame rate of the incoming stream rate is slower than the output or by removing video frames when the incoming stream rate is faster than the output.

Freestanding clock generators with sufficient accuracy are prohibitively expensive and generally cannot be used in consumer equipment. In television systems that broadcast directly to the viewer it is required that the decoder is as simple as possible in order to minimize its cost and so complex means of synchronizing the system are not desirable. In view of this requirement, in traditional direct to home broadcast networks such as Digital Video Broadcasting standards DVB-S, DVB-C, DVB-T for example or Advanced Television Systems Committee (ATSC) systems, a direct point-to-point synchronous connection between the encoder and the decoder is provided so that the decoder can maintain the required time base lock using the underlying reference clock which is carried in the connection path. In such networks it is assumed that the path from the broadcast source to the viewer's receiver is substantially free of timing aberrations and that any intermediate processing of the source streams take account of the need to maintain proper synchronization at all times.

In many networks there is a direct connection between the creating node and the receiving node, and the time base may be transferred over the network synchronously with the traffic data. However, in recent years there has been a substantial move towards the use of asynchronous transmission systems in which no direct connection path between the transmitter and receiver exists. One example of such an asynchronous transmission system is an Internet Protocol (IP) network. Asynchronous transmission techniques, such as those found in Internet Protocol (IP) networks, can insert considerable timing disturbances to data streams that pass through them.

An exemplary network configuration is shown in FIG. 1. In the network configuration shown in FIG. 1, a signal generated by a first device 10 is transmitted to a second device 12 via, at least in part, an asynchronous network 14. This situation may arise in the context of the transmission of variable data rate traffic data, for example compression coded video signals.

Once synchronism is lost in current practical systems using internet protocol (IP) methods of transmission, local corrective action is not possible and disruption to services will continue uncorrected. No simple method is available for ensuring that the time base of the second device 12 remains synchronized with the time base of the first device 10 in view of timing disturbances introduced by the asynchronous network 14 in the variable data rate traffic data sent from the first device 10 to the second device 12.

The present invention seeks to alleviate or ameliorate disadvantages in the prior art and to provide a novel method and apparatus for establishing a time base for variable data rate traffic data received over an asynchronous network.

### SUMMARY

In accordance with one aspect of the invention, there is provide a method of establishing a traffic data time base for variable data rate traffic data received over an asynchronous network. In a first step a time base for the traffic data is established using a first method of time base recovery. In a second step a reliability metric is determined for the first method. In a third step it is determined whether the reliability metric for the first method is acceptable. In a fourth step in response to a determination that the reliability metric for the first method is not acceptable, a time base for the traffic data is established using a second method of time-base recovery.

In some embodiments, during a period in which a time base for the traffic data is established using the second method of time base recovery a reliability metric for the first method of time-base recovery is determine and whether the reliability metric for the first method is acceptable is determined. In response to a determination that the reliability metric for the first method is acceptable, a time base for the traffic data is re-synchronised to a time base using the first method of time base recovery.

In some embodiments information used in determining the reliability metric is also used in establishing the time base for the traffic data using a first method of time base recovery.

In some embodiments the reliability metric is compared with a threshold value to determine whether the reliability metric for the first method is acceptable.

In some embodiments the threshold value for the first reliability metric is formed from combining previous values of the reliability metric.

In some embodiments the arrival timing of asynchronous network data is used to establish a time base for the traffic data using a first method of time-base recovery.

In some embodiments the arrival timing of asynchronous network data is used to determine the reliability metric.

In some embodiments an internal traffic data time base is used in establishing a time-base for the traffic data using a second method of time-base recovery.

In some embodiments the traffic data comprises a compression coded signal.

In some embodiments, the asynchronous network is an Internet Protocol (IP) network.

In some embodiments a notification is generated in response to a determination that the reliability metric for the first method is not acceptable.

In some embodiments the reliability of the second method of time base recovery is determined during a period in which a time base for the traffic data is established using the first method of time base recovery.

In some embodiments the reliability of the second method of time base recovery is determined by establishing a time-base for the traffic data using a second method of time-base recovery; and determining whether the time base established using the second method of time base recovery corresponds with the time base established using the first method of time base recovery.

In some embodiments a notification is generated in response to a negative determination that the time bases established using the first method and second method of time base recovery correspond.

In accordance with a further aspect of the invention, there is provide an apparatus establishing a traffic data time base for traffic data received over an asynchronous network. The apparatus has a first time base establishment element coupled to receive first time base information (94) and operable to establish a time base for the traffic data using a first method of time-base recovery. The apparatus has a second time base establishment element coupled to receive second time base information and operable to establish a time-base for the traffic data using a second method of time-base recovery. The apparatus has a reliability determining element, coupled to receive first time base information , the reliability determining element being operable to determine a reliability metric for the first method; and to determine whether the reliability metric for the first method is acceptable; and being coupled to the second time base establishment element to select a time base established by the second time base establishment element in response to a determination that the reliability metric for the first method is not acceptable.

In some embodiments the reliability determining element is coupled to a store in which is stored reliability information, and the reliability determining element is operable to determine whether the reliability metric for the first method is acceptable using the reliability information.

In some embodiments the reliability determining element is operable to form reliability information from first time base information and to store reliability information in the store.

In embodiments of the invention the time base for variable data rate traffic data received over an asynchronous network such as an Internet Protocol (IP) network can be established, thus enabling a decoder to remain synchronized with an encoder across an asynchronous network such as an Internet Protocol (IP) network without requiring the additional storage and control means that characterizes the traditional solution to this problem.

### DESCRIPTION OF DRAWINGS

FIG. 1 is schematic diagram showing an exemplary network configuration;

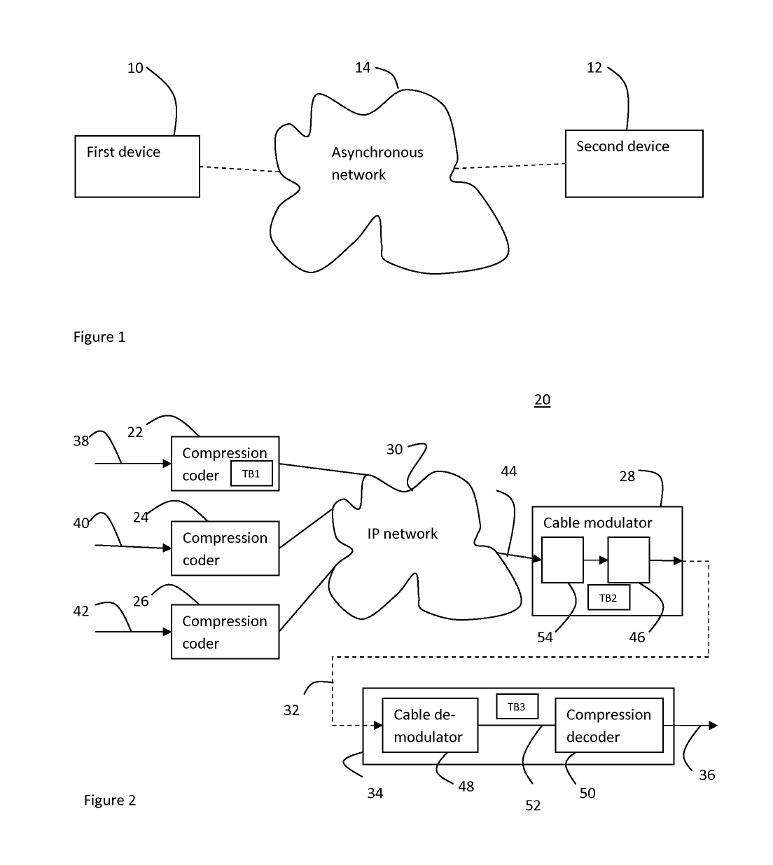

FIG. 2 is an outline schematic diagram of a network arrangement in which embodiments of the invention may be implemented;

FIG. 3 is a state diagram showing states of operation in accordance with embodiments of the invention;

FIG. 4 is a flow chart showing a method of establishing a time base in accordance with embodiments of the invention;

FIG. 5 is a schematic diagram of an exemplary element of FIG. 2;

FIG. 6 is a schematic diagram showing a time base determining element of FIG. 5 in accordance with one embodiment of the invention; and

FIG. 7 is a flow chart showing a method of establishing a time base in accordance with a further embodiment of the invention.

### DETAILED DESCRIPTION

The present invention will now be described with reference to the accompanying drawings.

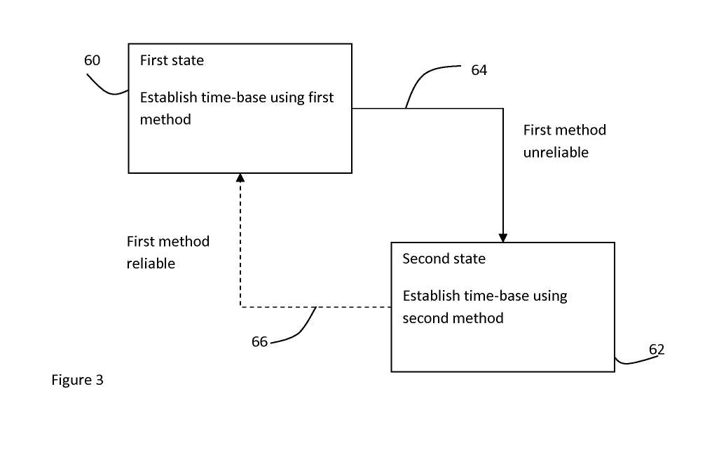

FIG. 2 is an outline schematic diagram of a network arrangement in which embodiments of the invention may be implemented. As will be clear from the following description, this arrangement is one example of a situation in which time base synchronization across an asynchronous network is required.

FIG. 2 shows an exemplary network arrangement 20 suitable for use by a large cable operator, in which compression coded video signals are collected from multiple sources 22, 24, 26 by a cable modulator 28, for example using an asynchronous network such as internet protocol (IP) network 30. The compression coded video signals are modulated for distribution over a cable network 32 to cable consumer equipment 34. At the cable consumer equipment 34 the received cable modulated signal can be demodulated and the resulting compression coded video signals can be compression decoded to provide a compression decoded video signal 36 for the consumer.

Three exemplary compression coders 22, 24, 26 are shown in FIG. 2, each of which is coupled to a respective input video signal 38, 40, 42. Clearly, in a practical system there might be any number of sources of the compression coded signals. Each of the compression coders 22, 24, 26 is operable to compression code the respective input video signal 38, 40, 42 in accordance with a compression coding scheme. Suitable compression schemes are well known to a skilled person, and will not be explained in further detail.

The compression coders 22, 24, 26 are each provided with a clock (not shown) used during the compression coding process carried out by that compression coder 22, 24, 26. For the sake of clarity, the clock time base TB 1 that is associated with compressed signals from the compression coder 22 is shown schematically in FIG. 2, but it will be understood that a respective clock time base will be associated with compression coded video signals produced by the compression coders 22, 24, 26.

The plurality of compression coders 22, 24, 26 are arranged to transmit a respective compression coded video signal asynchronously over the Internet Protocol (IP) network 30, and the cable modulator 28 is arranged to receive a plurality of compressed video channels 44 transmitted asynchronously over the internet protocol (IP) internet protocol (IP) network 30 from the plurality of compression coders 22, 24, 26.

The cable modulator 28 is provided with a cable modulating unit 46 that is coupled via cable network 32 to consumer equipment 34. The cable modulating unit 46 is operable to modulate the received plurality of compressed video channels 44 for transmission in the cable network 32, and to transmit the resulting cable modulated signals to the consumer equipment 34. The modulation of signals for transmission in a cable network is well known to a skilled person, and therefore will not be explained in more detail. The clock (not shown) of the cable modulator 28 provides a time base TB2 used by the cable modulating unit 46 during the modulation of the compressed video signals for distribution over the cable network 32 to cable consumer equipment 34.

The consumer equipment 34 has a cable demodulator 48 and a compression decoder 50. The cable de-modulator 48 is coupled to the cable modulating unit 46 of the cable modulator 28 via the cable network 32, to receive and to decode the cable modulated signal to obtain a compression coded video signal 52. The compression decoder 50 is coupled to the cable demodulator 48 to receive the compression coded video signal 52 and is operable to compression decode the compression coded signal 52 to obtain the video signal 36 for presentation to the consumer. The time base TB3, shown schematically in FIG. 2, derived from the clock (not shown) of the consumer equipment 34 is used by both the cable demodulator 48 and the compression decoder 50.

As will be appreciated by a skilled person, the time base TB3 of the consumer equipment 34 is synchronized to the time base TB2 of the cable modulator 28 relatively easily across the cable network 32, which enables the cable modulated signal to be easily decoded. However, for an exemplary compression coded signal from compression coder 22, unless the time base TB3 of the consumer equipment 34, which is used by the compression decoder 50 during the compression decoding process, can be synchronized with the time base TB1 of compression coder 22 that was used during the video compression process, an error may occur during compression decoding of the compression coded video signals.

Thus, in accordance with embodiments of the invention as shown in FIG. 2, cable modulator 28 is also provided with a front end element 54. The front end element 54 of the cable modulator 28 is coupled to the internet protocol (IP) network 30, as an exemplary asynchronous network, to receive from the internet protocol (IP) network 30 a plurality of compressed video signals 42 as exemplary traffic data. The front end element 54 is able to establish a time base TB2 for variable data rate traffic data such as the compression coded video signals, received over an asynchronous network such as internet protocol (IP) network 30. Thus in embodiments of the invention as will be discussed in the following description, the time base TB2 is synchronized with the time base TB1 of the exemplary compression coder 22 despite the transmission of the compression coded video signals over the asynchronous internet protocol (IP) network 30.

Since the time base TB3 is easily synchronized with the time base TB2 owing to the synchronous nature of transmission over the cable network 32, the time base TB3 for the compression decoder 46 can be synchronized with the time base TB1 of the exemplary compression coder 22 despite the presence of the asynchronous internet protocol (IP) network 30 in the transmission train.

In accordance with embodiments of the invention, the time base TB2 is stabilized and synchronized with the time base TB1 by time base recovery action carried out in the cable modulator 28. More specifically, in accordance with embodiments of the invention, the front end element 38 of the cable modulator 28 recovers the time base TB2 for traffic data received over the asynchronous internet protocol (IP) network 30.

In accordance with embodiments of the invention at least two methods of establishing a time base TB2 for variable data rate traffic data received over an asynchronous network are available to the front end element 38 of the cable modulator 28. The front end element 38 monitors the reliability of a first method being used to establish a time base TB2 and switches to a second method of establishing the time base TB2 if the reliability monitoring reveals that the first method is unreliable.

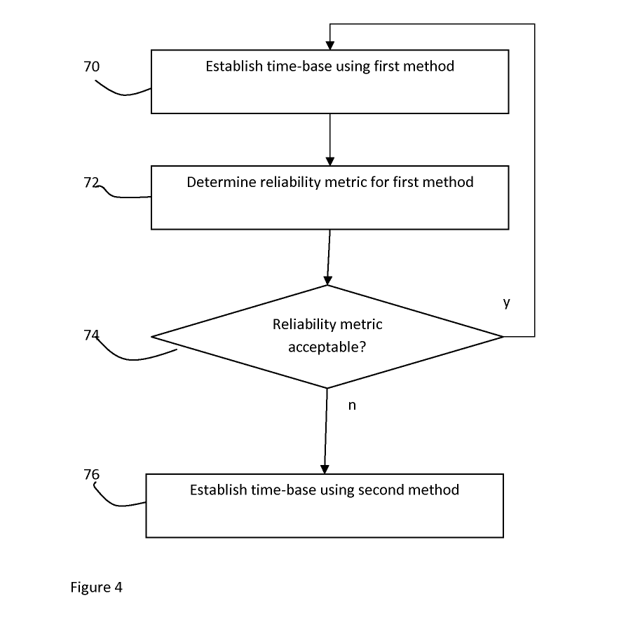

FIG. 3 is a state diagram showing states of operation in accordance with embodiments of the invention.

In a first state 60, a time-base TB2 for variable data rate traffic data received over an asynchronous network is established using a first method.

In a second state 62, a time-base TB2 for variable data rate traffic data received over an asynchronous network is established using a second method.

A transition 64 is made from the first state 60 to the second state 62 in response to the first method of establishing the time base TB2 being considered unreliable.

In some embodiments, a transition 66 from the second state 62, in which the time base TB2 is established using the second method, to the first state 60, in which the time base TB2 is established using the first method, is made in response to the first method of establishing the time base being considered reliable. However, this transition is not used in all embodiments, and has therefore been indicated in dashed lines only.

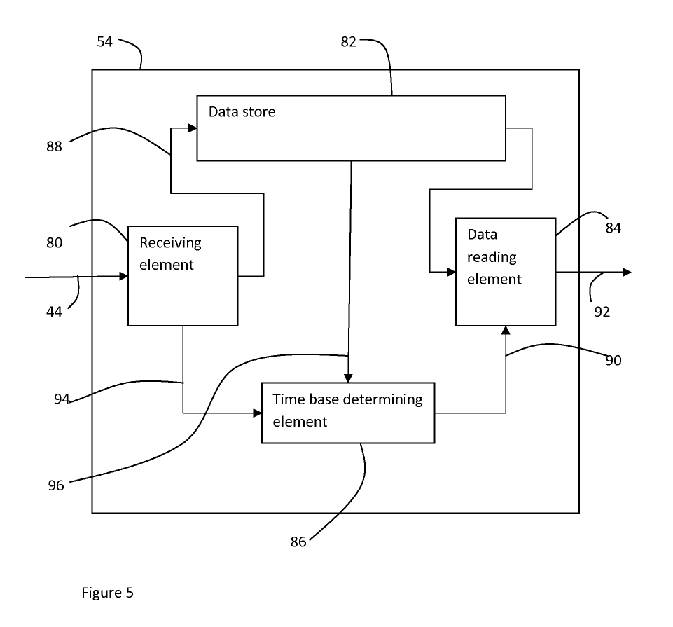

A method of establishing a time base in accordance with embodiments of the invention will now be described with reference to FIG. 4.

In a first step 70, the time base of variable data rate traffic data received across an asynchronous network is established using a first method.

In a second step 72, a reliability metric for the first method is determined. In embodiments of the invention the reliability metric is selected to measure or reflect the reliability of the first method in establishing the time base. Clearly, in different embodiments a different reliability metric may be selected.

In step 74, it is determined whether the reliability metric is acceptable.

The reliability metric is acceptable when the first method establishes a reliable time base. In some embodiments, the reliability metric is compared with one or more threshold values, and the result of the comparison determines whether reliability metric is acceptable.

In different embodiments different thresholds can be selected by a skilled person, for example in dependence on the tolerance of the decoder to jitter and variation in the time base. Therefore, for example, in the embodiment shown in FIG. 2, if the decoder 50 is more tolerant of time base variation, the threshold of the reliability metric may be set to cause switching to the second method at less reliable level of the first method than if the decoder is less tolerant of time base variation.

In some embodiments, the threshold values used in determining whether the reliability metric is acceptable are determined from historical measurements of the reliability metric.

In some embodiments, the first method of establishing the time base uses information that is used to form the reliability metric.

All of steps 70-74 are carried out in the first state 60 shown in FIG. 3.

If the first method is reliable, step 74-y, the reliability metric of the first method determined in step 72 will be acceptable, and the operation remains in the first state 60 as the method returns to step 70.

However, if the method is unreliable and the reliability metric for the first method determined in step 72 is found to be unacceptable, step 74-n, the transition 64 is made from the first state 60 to the second state 62, and the method of FIG. 4 enters step 76. In step 76 the time base of traffic data received across an asynchronous network is established using a second method.

The first and second methods of establishing a time base for traffic data received across a synchronous network in accordance with some embodiments of the invention will be explained in more detail in the following description. The determination of a reliability metric for the first method of establishing a time base will also be described in more detail in the following description.

In the exemplary embodiment the first method used to establish the time base TB2 is based on the data arrival timing of the traffic data arriving from the synchronous network. This method is based on the fact that for some periods of time it is possible that the latency across the internet protocol (IP) network could be relatively stable and so it could be assumed that the asynchronous network data arrival timing, averaged over such a period of time, is representative of the transmission timing and hence could be used in establishing the time base for the traffic data. In the exemplary embodiment shown in FIG. 2 the arrival time of internet protocol (IP) packets received across an internet protocol (IP) network are used to establish a time base TB2 that is synchronized to the originating time base TB1

This is a reliable method for establishing the time base if the assumption that the latency through the network holds and depends on there being no exceptional event in the asynchronous network which would cause the latency across the network to change significantly. However, unpredictable and perhaps sudden changes in the internet protocol (IP) network latency will invalidate this assumption and cause the time base TB2 recovered using this manner to become unsynchronized with the time base TB1 of the traffic data being sent across the asynchronous network.

The reliability of this method may be monitored by measuring the consistency of the asynchronous network data arrival timing. In accordance with an exemplary embodiment, a reliability metric is formed from the asynchronous network data arrival timing.

In the exemplary embodiment of the invention this assumption is monitored by keeping statistics on the inter-packet arrival times on the internet protocol (IP) network. There will be some short-term variation in the arrival time but this can be corrected using a simple averaging filter over several packets.

Therefore in accordance with the exemplary embodiment the time base is established based on the arrival timing of the asynchronous network data. The consistency of arrival timing of the asynchronous network data is monitored to form a reliability metric to assess the reliability of the method of establishing the time base. If the arrival timing is consistent, then it may be assumed that the latency is broadly constant and that the time base established using this method is reliable.

In some embodiments the reliability metric for the first method may be established by monitoring the medium-term average time between the arrival times of contiguous packets. If the value for the medium term average arrival timing falls outside specified limits, the reliability metric is not acceptable and the method and the time base established using the method, can be considered unreliable. In this situation, the second method can be used to establish the time base.

In some embodiments, a valid range (maximum time and minimum time) for the reliability metric is determined by measuring the variation over a lengthy period of time (several days), for example as a system training exercise during the installation phase. The network operator must ensure that there are no exceptional events during this exercise to obtain a good result but this can be monitored by generating a series of statistics with a much shorter period to see if there was any short period where the variation was significantly different. If there are, the statistics for this event are removed from the final analysis.

In the exemplary embodiment, the second method used to establish the time base uses an internal time base of the traffic data. This method depends on the assumption that the internal time base within the transport stream (TS) sequence is valid.

Thus in an exemplary embodiment in which the traffic data is a transport stream (TS) sequence for a compressed video signal, the time base is established based on an internal time base of the transport stream [TS] sequence arriving at the receiver, since the incoming transport stream (TS) sequence contains regular timing references derived from the encoder 27 MHz time base.

If the transport stream (TS) sequence has not been modified since it was encoded, then this is an acceptable source for time base recovery as there is a maximum time base jitter specified as part of the MPEG systems specification.

In some embodiments, as discussed previously, once the reliability metric of the first method indicates that the first method is reliable, the first method is used to establish the time base once more.

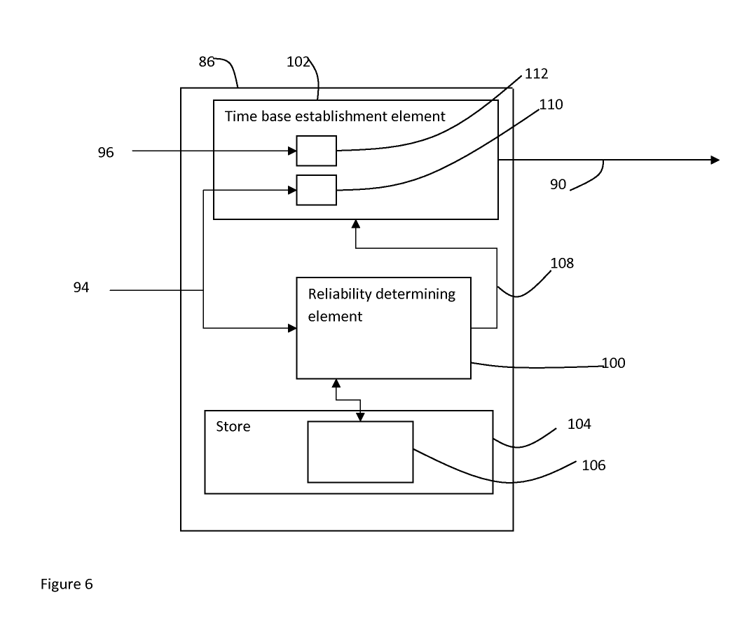

The method in accordance with embodiments of the invention as described above with reference to FIG. 3 may be implemented in a front end element 54 of the cable modulator 28 in the exemplary network arrangement shown in FIG. 2. An exemplary embodiment of a front end element 54 will now be described with reference to FIG. 5.

The front end element 54 comprises a receiving element 80, a data store 82; a data reading element 84; and a time base determining element 86. Although the data store 82 and the data reading element 84 are shown as part of the exemplary front end element 54 of the cable modulator 28 shown in FIG. 5, in some embodiments these elements may be located elsewhere in the cable modulator 28. For example, the data reading element 84 may be implemented as a part of the cable modulating unit 40 of the cable modulator 28.

The receiving element 80 is arranged to receive traffic data from an asynchronous network 30. In the exemplary embodiment, the receiving element 80 is arranged to receive internet protocol (IP) packets containing compressed video signals 44 from the asynchronous internet protocol (IP) network 30.

The receiving element 80 is coupled to the data store 82, and is operable to extract the traffic data from the packets received from the asynchronous internet protocol (IP) network 30, and to store the resulting traffic data 88 in the data store 82. In the exemplary embodiment in which the traffic data is a compressed video channels, the packet receiving element 80 is operable to extract the compressed transport stream 88 from a received internet protocol (IP) packet, and to store the transport stream 88 in the data store 82.

The data reading element 84 is coupled to the time base determining element 86 to receive a time base 90. The data reading element 84 is coupled to the data store 82 and is arranged to read out, under the control of the time base 90 received from the time base determining element 86, the stored traffic data and to output the stored traffic data 92 for further processing. In the exemplary embodiment, the compressed transport stream forming traffic data 92 is passed to the cable modulating unit 46 of the cable modulator 28, shown in FIG. 2, for modulation and for onward transmission in the cable network 32.

In the exemplary arrangement shown in FIG. 5, the time base determining element 86 is coupled to the receiving element 80 to receive first time base information 94 from the packet receiving element 80. In the exemplary embodiment, the first time base information 94 is asynchronous network data arrival time. In addition, the time base determining element 86 is also coupled to the data store to receive from the data store second time base information 96. In the exemplary embodiment the second time base information 96 is an internal time base of the traffic data.

As will be described later, in the exemplary embodiment the time base determining element 86 uses the first time base information 94 to establish a time base using the first method and also to determine the reliability metric for the first method. In the exemplary embodiment, the time base determining element 86 uses the second time base information 96 to establish a time base using the second method.

The time base determining element 86 operates in accordance with the method as set out in FIG. 4 using the first time base information 94 and the second time base information 96 to establish a time base 90. The time base determining element 86 supplies the time base 90 to the data reading element 84.

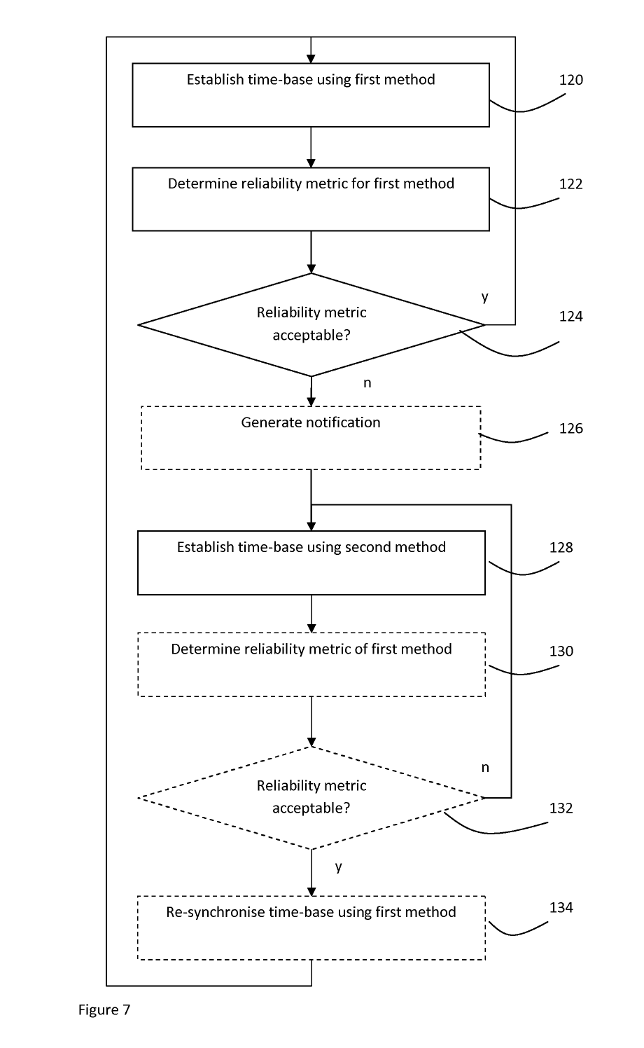

An exemplary arrangement of the time base determining element 86 in accordance with one embodiment of the invention will now be described with reference to FIG. 6.

The time base determining element 86 is provided with a reliability determining element 100; a time base establishment element 102; and a store 104, in which is stored reliability information 106. Although the store 104 is shown as part of the time base determining element 86, in some embodiments the store 104 may be implemented in other ways, for example as part of a larger memory store within the front end 54 or within the cable modulator 28.

The reliability determining element 100 is coupled to the receiving element 80 to receive first time base information 94. The reliability determining element 100 is also coupled to the store 104 so as to read reliability information 106 from the store 104. In some embodiments, as will be described in more detail in the following description, the reliability determining element 100 is coupled to the store 104 to store reliability information 106 in the store 104. The reliability determining element 100 is operable to determine the reliability of the first method, and is coupled to the time base establishment element 102 to provide a reliability indication 108 for the reliability of the first method to the time base establishment element 102.

The time base establishment element 102 is provided with a first method element 110 that in the exemplary embodiment is coupled to the packet receiving element 80 (not shown in FIG. 6) to receive first time base information 94. The first method element 110 is operable to determine a time base from the first time base information 94.

In addition, the time base establishment element 102 is provided with a second method element 112 that in the exemplary embodiment is coupled to the data store 82 (not shown in FIG. 6) to receive second time base information 96. The second method element 112 is operable to determine a time base from the second time base information 96.

As mentioned above, the time base establishment element 102 is coupled to the reliability determining element 100 so as to receive reliability indication 108. The time base establishment element 102 uses reliability indication 108 to select whether the time base output of first method element 110 or the time base output of second method element 112 is to be output from the time base determining element 86.

Clearly, in different implementations the reliability indication 108 may be used to select which of the first method element 110 or the second method element 112 operates to establish the time base, or the first method element 110 and the second method element 112 may determine the time base continuously and the reliability indication 108 may be used to select which of the output of the first method element 110 or the output of the second method element 112 should be output as the time base from the time base establishment element 102.

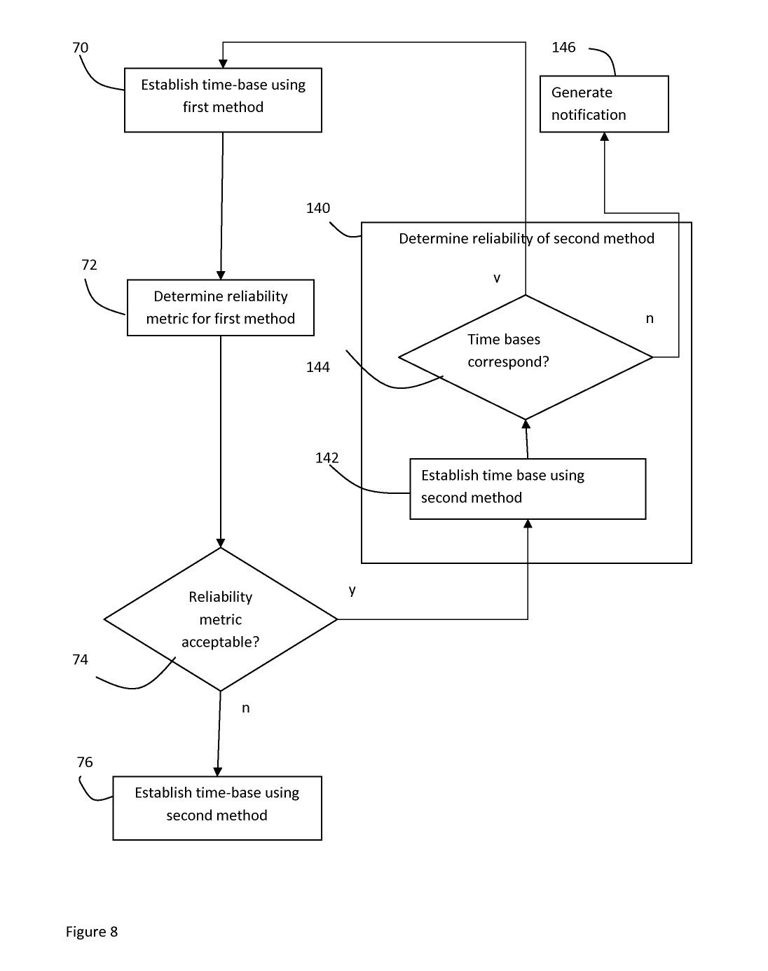

The method of operation of an embodiment in which the time base is established using the arrival time of internet protocol (IP) packets in a first method and is established using an internal time base of the traffic data in a second method will now be explained with reference to FIG. 7.

In a first step 120, the time base of traffic data received across an asynchronous network is established using a first method. In the exemplary embodiment, the first method element 104 is arranged to receive packet arrival information 94 from the packet receiving element 80 shown in FIG. 5 and carries out the first method of establishing the time base using the packet arrival information 94. Such methods will be well known to a skilled person and therefore will not be described in detail.

In a second step 122 a reliability metric for the first method is determined. The reliability metric may be determined by keeping statistics on the inter-packet arrival times on the internet protocol (IP) network. There will be some short-term variation in the arrival time but this can be corrected using a simple averaging filter over several packets. The consistency of arrival timing of the asynchronous network data is monitored to form a reliability metric. In the exemplary embodiment, the reliability metric for the first method may be established by monitoring the medium-term average time between the arrival times of contiguous packets.

In step 124, it is determined whether the reliability metric is within a determined range. In the exemplary embodiment, if the arrival timing is consistent then it may be assumed that the latency is broadly constant and that the time base established using this method is reliable. If the first method is reliable, the reliability metric of the first method determined in step 72 will be within the determined range, step 74-n, and the operation remains in the first state 60 as the method returns to step 120.

However, if the reliability metric, formed by the medium term average arrival timing of packets in the asynchronous IP network, falls outside specified limits, the reliability metric is not acceptable and the method of establishing the time base, and hence the time base established using the method, can be considered unreliable. In this situation, the second method can be used to establish the time base. Thus if the method is unreliable and the reliability metric for the first method determined in step 122 falls outside the determined range, step 124-y, the transition 64 is made from the first state 60 to the second state 62.

It is noted that all of steps 120-124 are carried out in the first state 60 shown in FIG. 3.

In some embodiments, such as the exemplary embodiment shown in FIG. 7, the operator is informed that the first method is unreliable in step 126. However, this is not necessary in all embodiments, and this step has therefore been shown in dashed lines.

Thereafter the method of FIG. 7 enters step 128 in which the time base of traffic data received across an asynchronous network is established using a second method. In the exemplary embodiment, the second method element 112 is arranged to receive packet transport stream information 96 from the data store 82 shown in FIG. 5 and carries out the second method of establishing the time base using the transport stream information 96. Again, such methods will be well known to a skilled person and therefore will not be described in detail.

In the exemplary method shown in FIG. 7 the reliability metric of the first method is determined in step 130 and in step 132 it is determined whether the reliability metric of the first method determined in step 130 will be within the determined range,.

If the first method is reliable, the reliability metric of the first method determined in step 72 will be within the determined range, step 74-n, and the operation remains in the first state 60 as the method returns to step 120.

The step of determining the reliability of the first method in step 130 corresponds to the step of determining the reliability of the first method in step 122, and will not be discussed further. In addition , the of determining whether the reliability metric is acceptable in step 132 corresponds with the step of determining whether the reliability metric is acceptable in step 124, and will not be discussed further.

Once again, steps 130-134 are not necessary in all embodiments and therefore have been shown in dashed lines.

A method in accordance with a further embodiment of the invention will now be described with reference to FIG. 8. FIG. 8 corresponds with FIG. 4, and the same steps in FIG. 8 have been given the same reference numbers as the corresponding steps in FIG. 4.

In this embodiment, in the first state 60, the internal time base of the incoming sequence may be monitored according to the second method outlined above as well as the arrival timing of the asynchronous network data arrival timing being monitored using the first method, as has been described above.

Thus if the first method reliability metric is acceptable as in step 74-y the current reliability of the second method of establishing the time base is determined, step 140.

To this end, in step 142, the time base is also established using the second method.

The time bases established using these two different methods during the operation in the first state 60 can be compared with each other so as to determine whether the second method of establishing the time base is performing reliably. Thus, in step 144, it is determined whether the time base established using the first method in step 70 corresponds with the time base established using the second method in step 142.

If the time bases correspond, 144-y, it can be concluded that the second method of establishing the time base is performing reliably, and the method can return to monitoring the time base using the first method as step 70.

If the time bases do not correspond, 144-n it can be concluded that the second method of establishing the time base is not performing reliably. In some embodiments a notification is generated in step 146.

Thus in accordance with embodiments of the invention, the establishment of the time base across an asynchronous network is disclosed. The establishment of the time base is made reliable in accordance with embodiments of the invention by monitoring underlying validity assumptions for the method used to establish the time base to ensure that the method remains valid. When the assumption becomes invalid, the system changes behavior to compensate by selecting a different method of establishing the time base.

Thus in accordance with embodiments of the invention, the time between the arrival times of contiguous internet protocol (IP) packets is monitored to determine whether the latency of the network is varying.

The internal time base of the incoming sequence is monitored and this time base is used to maintain the synchronization when the latency of the network is varying.

A re-synchronization of the time base back to the first method once the arrival times of contiguous internet protocol (IP) packets have returned to be within allowed values.

During the system setup, the arrival times of asynchronous network data are monitored over a reasonable period of time to determine the operation around the quiescent state.

Embodiments of the invention provide a method of and apparatus for establishing a traffic data time base. Embodiments of the invention may be implemented in software or hardware or any combination of hardware or software, as will be appreciated by a skilled person.

It will be understood by a skilled person that the method described herein may be implemented in many different ways, and the functional division described herein is merely exemplary and illustrative.

1. A method of establishing a traffic data time base for variable data rate traffic data received over an asynchronous network, the method comprising the steps of:
establishing a time base for the traffic data using a first method of time base recovery;
determining a reliability metric for the first method;
determining whether the reliability metric for the first method is acceptable; and
in response to a determination that the reliability metric for the first method is not acceptable, the step of establishing a time-base for the traffic data using a second method of time-base recovery.

2. The method as claimed in claim 1 in which, during a period in which a time base for the traffic data is established using the second method of time base recovery the method further including a step of:
determining a reliability metric for the first method of time-base recovery; and
determining whether the reliability metric for the first method is acceptable; and
in response to a determination that the reliability metric for the first method is acceptable, the step of re-synchronising a time-base for the traffic data using the first method of time-base recovery.

3. The method as claimed in claim 1, in which information used in the step of determining the reliability metric is also used in the step of establishing the time base for the traffic data using a first method of time base recovery.

4. The method as claimed in claim 1, wherein the step of determining whether the reliability metric for the first method is acceptable comprises the step of comparing the reliability metric with a threshold value.

5. The method as claimed in claim 4, wherein the threshold value for the first reliability metric is formed from combining previous values of the reliability metric.

6. The method as claimed in claim 1, in which the arrival timing of asynchronous network data is used in the step of establishing a time base for the traffic data using a first method of time-base recovery.

7. The method as claimed in claim 1, in which the arrival timing of asynchronous network data is used in the step of determining the reliability metric.

8. The method as claimed in claim 1, in which an internal traffic data time base is used in the step of establishing a time-base for the traffic data using a second method of time-base recovery.

9. The method as claimed in claim 1, wherein the traffic data comprises a compression coded signal.

10. The method as claimed in claim 1, wherein the asynchronous network is an Internet Protocol (IP) network.

11. The method as claimed in claim 1, further including the step of generating a notification in response to a determination that the reliability metric for the first method is not acceptable.

12. The method as claimed in claim 1, further including the step of determining the reliability of the second method of time base recovery during a period in which a time base for the traffic data is established using the first method of time base recovery.

13. The method as claimed in claim 12, in which the step of determining the reliability of the second method of time base recovery comprises the steps of:
establishing a time-base for the traffic data using a second method of time-base recovery; and
determining whether the time base established using the second method of time base recovery corresponds with the time base established using the first method of time base recovery.

14. The method as claimed in claim 13, further comprising the step of generating a notification in response to a negative determination that the time bases established using the first method and second method of time base recovery correspond.

15. An apparatus establishing a traffic data time base for traffic data received over an asynchronous network, comprising:
a first time base establishment element coupled to receive first time base information and operable to establish a time base for the traffic data using a first method of time-base recovery;
a second time base establishment element coupled to receive second time base information and operable to establish a time-base for the traffic data using a second method of time-base recovery; and
a reliability determining element, coupled to receive first time base information, the reliability determining element being operable to determine a reliability metric for the first method; and to determine whether the reliability metric for the first method is acceptable; and coupled to the second time base establishment element to select a time base established by the second time base establishment element in response to a determination that the reliability metric for the first method is not acceptable.

16. The apparatus as claimed in claim 15, in which the reliability determining element is coupled to a store in which is stored reliability information, wherein the reliability determining element is operable to determine whether the reliability metric for the first method is acceptable using the reliability information.

17. The apparatus as claimed in claim 16, in which the reliability determining element is operable to form reliability information from first time base information and to store reliability information in the store.
